(19) United States
(12) Patent Application Publication
(10) Pub. No.: US 2026/0208723 A1
(43) Pub. Date: Jul. 23, 2026

(54) VEHICLE DRIVING CONTROL APPARATUS AND METHOD, AND A VEHICLE INCLUDING THE SAME

(71) Applicants: HYUNDAI MOTOR COMPANY, Seoul (KR); KIA CORPORATION, Seoul (KR)

(72) Inventors: Young Myung Kim, Hwaseong-si (KR); Joon Shik Park, Hwaseong-si (KR); Ick Hwan Kim, Hwaseong-si (KR); Sang Hyeok Mo, Hwaseong-si (KR); Chang Min Lee, Hwaseong-si (KR); Yong Hoon Lee, Hwaseong-si (KR)

(73) Assignees: HYUNDAI MOTOR COMPANY, Seoul (KR); KIA CORPORATION, Seoul (KR)

(21) Appl. No.: 19/296,630

(22) Filed: Aug. 11, 2025

(30) Foreign Application Priority Data
Jan. 23, 2025 (KR) 10-2025-0010694

(51) Int. Cl. B60W 20/30; B60K 6/52; B60W 10/08; B60W 20/10; B60W 50/00

(52) U.S. Cl. CPC B60W 20/30; B60K 6/52; B60W 10/08; B60W 20/10; B60W 50/00; B60W 2050/0028; B60W 2510/0275; B60W 2510/1005; B60W 2510/1015; B60W 2520/403; B60W 2710/083; B60Y 2200/92; B60Y 2400/82

(57) ABSTRACT

An apparatus configured to control driving of a vehicle including a transmission arranged between a first driving wheel and a first motor and a second motor connected to a second driving wheel. The apparatus includes: a first controller configured to, based on power-on upshift occurring in the transmission, determine an input shaft compensation torque and a handover ratio over a handover period, and a second controller configured to determine whether compensation for the entire input shaft compensation torque is possible using the first motor and to control the first motor or control the first motor and the second motor based on the input shaft compensation torque and the handover ratio according to a determination result whether compensation is possible using the first motor.

### CROSS-REFERENCE TO THE RELATED APPLICATION

The present application claims the benefit of and priority to Korean Patent Application No. 10-2025-0010694, filed on Jan. 23, 2025, the disclosure of which is incorporated herein by reference in its entirety.

### 1. TECHNICAL FIELD

The present disclosure relates to technology for controlling driving of a vehicle.

### 2. BACKGROUND

A transmission is used to optimize driving efficiency when driving a vehicle. Transmissions are broadly classified into manual transmissions and automatic transmissions. Automatic transmissions include A/T transmissions (e.g., including a torque converter) and a dual clutch transmission (DCT).

Among the basic shifting types of A/T and DCT, power-on upshift is shifting to an upper or higher gear when a vehicle speed increases to a certain speed or higher in consideration of efficiency in a situation in which the driver wishes to accelerate (i.e., the accelerator position sensor (APS) is on).

In a period (“handover period”) in which the release-side torque and the engagement-side torque exchange during power-on upshift, friction loss occurs due to an increase in the engagement-side torque.

In the past, in vehicles in which an automatic transmission is disposed between driving wheels and a driving source, friction loss in a handover period was compensated for by using a spare or additional torque of (e.g., provided by) the driving source.

However, if a torque limitation by rotations per minute (RPM) is applied to the driving source, such as a driving motor (i.e., the maximum output of the driving motor is limited), it is difficult for the driving source to provide additional torque to compensate for the friction loss. In other words, if torque limitation by rpm is applied to the driving motor, friction loss compensation using the driving motor cannot be performed in a handover period.

Therefore, a method of compensating for clutch friction loss that occurs in a handover period during power-on upshift in circumstances when a torque limitation by RPM is applied to the driving source is required.

The matters described as the background above are provided only for the purpose of enhancing understanding of the background of the present disclosure. Thus, the presence of information provided above in the Background section is not an acknowledgement that the above information corresponds to prior art already known to those of ordinary skill in the art.

### SUMMARY

The present disclosure provides an improved vehicle driving control apparatus and method capable of maintaining acceleration linearity in a handover period during power-on upshift, and a vehicle including the same.

The present disclosure also provides an improved vehicle driving control apparatus and method capable of compensating for clutch friction loss of a transmission even when clutch friction loss compensation using a spare torque of a front wheel motor is impossible due to torque limitation of the front wheel motor, and a vehicle including the same.

The present disclosure may also provide an improved vehicle driving control apparatus and method capable of compensating for an insufficiency in compensation torque which is not compensated for by the front wheel motor in an input shaft compensation torque, by driving of the rear wheel motor, and a vehicle including the same.

Technical objects to be achieved by the present disclosure are not limited to the technical objects mentioned above, and other technical objects not mentioned should be clearly understood by those of ordinary skill in the art to which the present disclosure belongs from the description below.

In accordance with an aspect of the present disclosure, the above and other objects can be accomplished by the provision of an apparatus for controlling driving of a vehicle including a transmission arranged between a first driving wheel and a first motor and a second motor connected to a second driving wheel. The apparatus includes: a first controller configured to, based on power-on upshift occurring in the transmission, determine an input shaft compensation torque and a handover ratio over a handover period, and a second controller configured to determine whether compensation for the entire input shaft compensation torque is possible using the first motor and not the second motor and to control the first motor and not the second motor or control the first motor and the second motor based on the input shaft compensation torque and the handover ratio, according to a determination result whether compensation is possible using the first motor and not the second motor.

According to an embodiment of the present disclosure, the first controller may determine the input shaft compensation torque α based on mathematical expression 1.

$$α = \frac{( {ω}_{i} - {ω}_{y} ) \times ( {T}_{y} - {T}_{y e} )}{{ω}_{i}} \times F \qquad [ Mathematical expression 1 ]$$

Here, ωᵢ is an input shaft speed, ω_{y} is rpm of an engagement-side clutch, T_{y} is an engagement-side clutch torque at a handover end time, T_{ye} is an engagement-side clutch torque at a handover start time, and F is a correction coefficient.

According to an embodiment of the present disclosure, the first controller may determine a smaller value between a first handover ratio determined based on a time ratio and a second handover ratio determined based on a torque ratio as the handover ratio.

According to an embodiment of the present disclosure, the second controller may determine whether compensation for the entire input shaft compensation torque is possible using the first motor and not the second motor based on a result of comparison between a sum of a starting point input torque corresponding to a torque of an input shaft at a handover start time and the input shaft compensation torque, and a maximum input torque preset for the transmission.

According to an embodiment of the present disclosure, the second controller may, based on a driving mode of the vehicle being charge-depleting (CD) mode, apply an EV maximum torque corresponding to a maximum torque in an EV mode as the maximum input torque, and determine that compensation for the entire input shaft compensation torque is not possible using the first motor and not the second motor based on the sum of the starting point input torque and the input shaft compensation torque being greater than the EV maximum torque.

According to an embodiment of the present disclosure, the second controller may, based on the driving mode of the vehicle being a charge-sustaining (CS) mode, apply a maximum torque per stage as the maximum input torque, and determine that compensation for the entire input shaft compensation torque is not possible using the first motor and not the second motor based on the sum of the starting point input torque and the input shaft compensation torque being greater than the maximum torque per stage.

According to an embodiment of the present disclosure, based on determining that compensation for the entire input shaft compensation torque is possible using the first motor and not the second motor, the second controller may determine an input shaft torque for the first motor based on the input shaft compensation torque, the handover ratio, and the starting point input torque corresponding to the torque of the input shaft at the handover start time, and output the input shaft torque to a first motor controller for controlling the first motor.

According to an embodiment of the present disclosure, the second controller may determine the input shaft torque for the first motor by adding a product of the input shaft compensation torque and the handover ratio to the starting point input torque.

According to an embodiment of the present disclosure, the second controller may determine an additional compensation torque to be applied by the second motor to compensate for an insufficient compensation torque that has not been compensated for using the first motor based on determining that compensation for the entire input shaft compensation torque is not possible using the first motor.

According to an embodiment of the present disclosure, the second controller may determine the additional compensation torque γ based on mathematical expression 4.

$$γ = \frac{front wheel motor final gear ratio}{rear wheel motor final gear ratio} \times ( {T}_{i s} + α - maximum torque ) \qquad [ Mathematical expression 4 ]$$

Here, Tᵢₛ is the starting point input torque corresponding to the torque of the input shaft at the handover start time, α is the input shaft compensation torque, the front wheel motor final gear ratio is a gear ratio of a front wheel final reduction gear, the rear motor final gear ratio is a gear ratio of a rear wheel final reduction gear, and the maximum torque is the EV maximum torque in the CD mode and the maximum torque per stage in the CS mode.

According to an embodiment of the present disclosure, the second controller may determine the input shaft torque for the first motor based on the input shaft compensation torque, the handover ratio, and the starting point input torque corresponding to the torque of the input shaft at the handover start time, and determine a rear wheel motor compensation torque based on the additional compensation torque and the handover ratio.

According to an embodiment of the present disclosure, the second controller may determine the input shaft torque for the first motor by adding the product of the input shaft compensation torque and the handover ratio to the starting point input torque.

According to an embodiment of the present disclosure, the second controller may determine the rear wheel motor compensation torque by multiplying the additional compensation torque by the handover ratio.

According to an embodiment of the present disclosure, the second controller may output the input shaft torque to the first motor controller for controlling the first motor, and output the rear wheel motor compensation torque to a second motor controller for controlling the second motor.

According to an embodiment of the present disclosure, the first motor controller may control the first motor based on the input shaft torque such that the transmission operates at a maximum torque, and the second motor controller may control the second motor based on the rear wheel motor compensation torque such that an insufficient compensation torque that has not been compensated using the first motor in the input compensation torque is compensated for according to driving of the second motor.

In accordance with another embodiment of the present disclosure, there is provided a method of controlling driving of a vehicle including a transmission arranged between a first driving wheel and a first motor and a second motor connected to a second driving wheel. The method includes: determining, by a first controller, an input shaft compensation torque and a handover ratio over a handover period based on power-on upshift occurring in the transmission; determining, by a second controller, whether compensation for the entire input shaft compensation torque is possible using the first motor and not the second motor by a second controller; and controlling the first motor and not the second motor or controlling the first motor and the second motor, by the second controller, based on the input shaft compensation torque and the handover ratio according to a determination result whether compensation is possible using the first motor and not the second motor.

In accordance with another embodiment of the present disclosure, a vehicle includes a first powertrain including a first motor and a transmission arranged between the first motor and a first driving wheel, a second powertrain including a second motor connected to a second driving wheel, and a vehicle driving control apparatus configured to control the first powertrain and the second powertrain. In particular, based on power-on upshift occurring in the transmission, the vehicle driving control apparatus determines an input shaft compensation torque and a handover ratio, determines whether compensation for the entire input shaft compensation torque is possible using the first motor and not the second motor, and controls the first motor and not the second motor or controls the first motor and the second motor based on the input shaft compensation torque and the handover ratio according to a determination result whether compensation is possible using the first motor and not the second motor.

According to an embodiment of the present disclosure, the vehicle control apparatus may be configured to determine whether compensation for the entire input shaft compensation torque is possible using the first motor and not the second motor based on a result of comparison between a sum of a starting point input torque corresponding to a torque of an input shaft at a handover start time and the input shaft compensation torque, and a maximum input torque preset for the transmission.

According to an embodiment of the present disclosure, the vehicle control apparatus may be configured to determine a smaller value between a first handover ratio determined based on a time ratio and a second handover ratio determined based on a torque ratio as the handover ratio. According to an embodiment of the present disclosure, the vehicle control apparatus may be configured to determine an additional compensation torque to be applied by the second motor to compensate for an insufficient compensation torque that has not been compensated for using the first motor based on determining that compensation for the entire input shaft compensation torque is not possible using the first motor.

Specific details of various embodiments of the present disclosure other than the descriptions provided above for solving the problems mentioned above are included in the description and drawings below.

### BRIEF DESCRIPTION OF THE DRAWINGS

The above and other objects, features, and other advantages of the present disclosure should be more clearly understood from the following detailed description taken in conjunction with the accompanying drawings, in which:

FIG. 1 is a diagram showing an embodiment of a configuration of a power transmission system of a vehicle according to an embodiment of the present disclosure;

FIG. 2 is a diagram showing an embodiment of a control configuration for implementing vehicle driving control according to an embodiment of the present disclosure;

FIG. 3 is a diagram illustrating a vehicle driving control method according to an embodiment of the present disclosure;

FIG. 4 is a diagram illustrating a specific process of step S330 of FIG. 3; and

FIG. 5 is a graph showing improvement of acceleration linearity in a handover period in a situation in which the torque of a front wheel motor is limited when the vehicle driving control method according to an embodiment of the present disclosure is applied.

### DETAILED DESCRIPTION

In the following description, a detailed description of known functions and configurations incorporated herein has been omitted when a description thereof may obscure the subject matter of the present disclosure. The same reference numbers are used in the drawings to refer to the same or like parts. In addition, the attached drawings are only intended to facilitate understanding of the embodiments disclosed in this specification, and the technical ideas disclosed in this specification are not limited by the attached drawings. The technical ideas disclosed in this specification should be understood to include all modifications, equivalents, or substitutes included in the spirit and technical scope of the present disclosure.

Terms such as “first” and/or “second” are used to describe various components, but such components are not limited by these terms. The terms are used to discriminate one component from another component.

An element described in the singular form is intended to include a plurality of elements unless the context clearly indicates otherwise.

In the present specification, the term “comprise” or “include” is intended to specify the presence of a described feature, number, step, operation, component, part, or a combination thereof, but should be understood as not excluding the possibility of the presence or addition of one or more other features, numbers, steps, operations, components, parts, or combinations thereof.

The suffixes “module” and “unit” of elements used in the following description are used for convenience of description and thus can be used interchangeably and do not have any distinguishable meanings or functions.

When a component is “coupled” or “connected” to another component, it should be understood that a third component may be present between the two components although the component may be directly coupled or connected to the other component. When a component is “directly coupled” or “directly connected” to another component, it should be understood that no element is present between the two components.

In addition, a unit or a control unit included in a name is a term widely used in naming a control device (controller) that controls a specific function of a vehicle, and does not mean a generic functional unit. When a component, unit, controller, device, element, apparatus or the like of the present disclosure is described as having a purpose or performing an operation, function, or the like, the component, unit, controller, device, element, or apparatus should be considered herein as being “configured to” meet that purpose or perform that operation or function. Each component, unit, controller, device, element, apparatus, and the like may separately embody or be included with a processor and a memory, such as a non-transitory computer readable media, as part of the apparatus.

A controller may include a communication device that communicates with other controllers or sensors to control related functions, a memory that stores an operating system or logic commands and input/output information, and one or more processors that perform determinations, computations, decisions, and the like necessary to control related functions.

Any number of components or various components in any of the configurations described in this specification may be included in the disclosure of this specification. Components may include any combination of features described in this specification and may be arranged in any of the various configurations described in this specification. The concepts regarding the structure and arrangement of the components of the present disclosure and the use and operations thereof may be applied to any number of examples in any combination as well as to specific examples discussed in this specification. Embodiments including various features in various arrangements are described below with reference to the drawings.

Hereinafter, various embodiments of the present disclosure are described in detail with reference to the attached drawings, and regardless of symbols, identical or similar components have been given the same reference numbers and redundant descriptions thereof have been omitted.

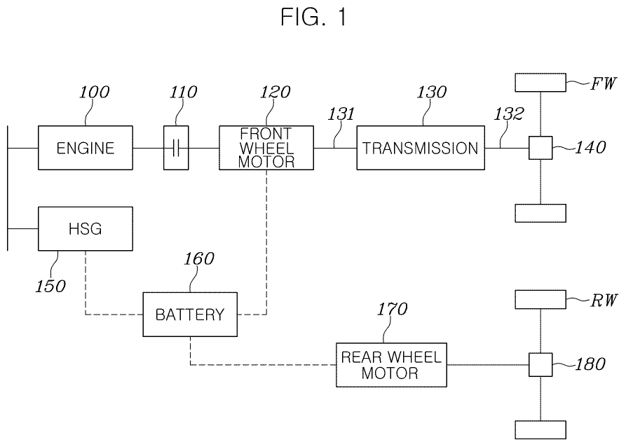

FIG. 1 is a diagram illustrating a configuration of a power transmission system of a vehicle according to an embodiment of the present disclosure.

FIG. 1 illustrates a power transmission system of a 4-wheel drive hybrid vehicle in which a front wheel powertrain including an engine 100 and a front wheel motor 120 and a rear wheel powertrain including a rear wheel motor 170 are combined.

According to an embodiment, the front wheel powertrain may include the engine 100, the front wheel motor (or first motor) 120, an engine clutch 110 disposed between the engine 100 and the front wheel motor 120 to transmit or cut off engine power, a transmission 130 that shifts and outputs the power of the front wheel motor 120, a front wheel final reduction gear (or first final reduction gear) 140 coupled to the transmission 130 and transmitting the power of the transmission 130 to the front wheels FW, a hybrid starter generator (HSG) 150 connected to the engine 100 to start the engine and generate power, and a battery 160 that is rechargeable and connected to the front wheel motor 120 and the hybrid starter generator 150.

In an embodiment, the transmission 130 may be implemented as an automatic transmission (AT) or a dual clutch transmission (DCT).

In an embodiment, the transmission 130 may be connected to the front wheel motor 120 by an input shaft 131 and connected to the front wheel final reduction gear 140 by an output shaft 132. Accordingly, the transmission 130 can convert a torque input through the input shaft 131 (hereinafter, input shaft torque) into an output shaft torque according to a shifting situation, and output the same to the output shaft 132.

According to an embodiment, the rear wheel powertrain may include the rear wheel motor (or second motor) 170 that is connected to the battery 160 such that the battery 160 is rechargeable, and a rear wheel final reduction gear (or second final reduction gear) 180 that outputs the power of the rear wheel motor 170 to the rear wheels RW.

According to an embodiment of the present disclosure, in a four-wheel drive hybrid vehicle in which the front wheel powertrain and the rear wheel powertrain are combined, when clutch friction loss occurring in a handover period during power-on upshift of the front wheel motor 120 cannot be compensated for using a spare torque of the front wheel motor 120, the clutch friction loss can be compensated for using the rear wheel motor 170.

Therefore, consistent acceleration linearity can be provided in a power-on upshift situation of the front wheel motor 120. Accordingly, occurrence of a feeling of deceleration, a feeling of power cut-off, and an unfamiliar shifting feeling (e.g., experienced by passenger(s) of the vehicle) can be prevented, ride comfort can be improved by maintaining acceleration linearity, and shifting consistency and robustness can be secured.

The vehicle configuration illustrated in FIG. 1 is assumed for convenience of description, and any vehicle including a transmission arranged between a first driving wheel and a first motor and a second motor connected to a second driving wheel is applicable to the embodiment of the present disclosure.

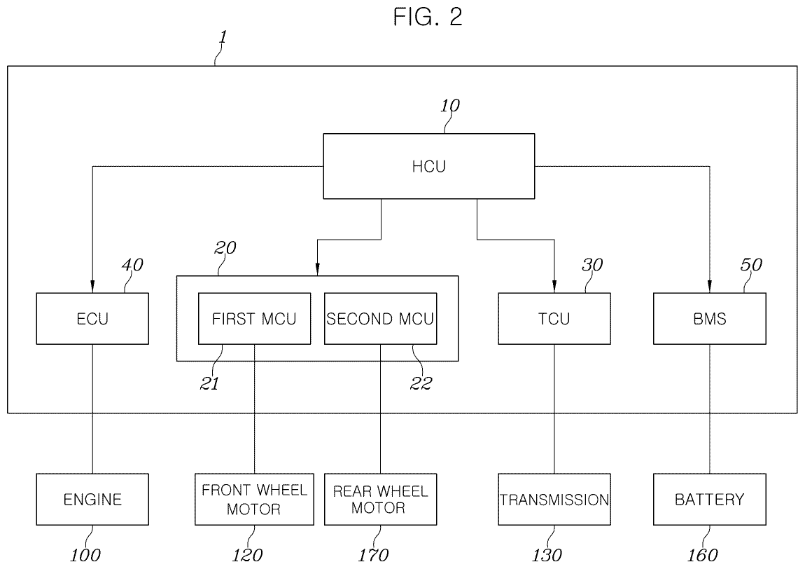

FIG. 2 is a diagram illustrating a control configuration for implementing vehicle driving control according to an embodiment of the present disclosure.

Referring to FIG. 2, a vehicle driving control apparatus 1 according to an embodiment of the present disclosure may include a hybrid control unit (HCU) 10, a motor control unit (MCU) 20, and a transmission control unit TCU (30).

According to an example, the driving control apparatus 1 may further include an engine control unit (ECU) 40 and a battery management system (BMS) 50.

The hybrid control unit 10 may be a high level control unit that distributes or determines a front wheel torque and a rear wheel torque at each gear according to driving situation. The hybrid control unit 10 may control low (e.g., lower) level control units such as the motor control unit 20, the transmission control unit 30, the engine control unit 40, and the battery management system 50.

For example, the hybrid control unit 10 may communicate with the low level control units based on a vehicle network, for example, a controller area network (CAN).

The hybrid control unit 10 may control the low level control units and receive information on devices or components (e.g., the engine, front wheel motor, rear wheel motor, transmission, battery, etc.) controlled and managed by the low level control units from the low level control units.

The motor control unit 20 may receive a torque command from the hybrid control unit 10 and control the overall operations of the front wheel motor 120 and the rear wheel motor 170. For example, the motor control unit 20 may include a first motor control unit 21 that controls the operation of the front wheel motor 120 and a second motor control unit 22 that controls the operation of the rear wheel motor 170.

The transmission control unit 30 may control the gear(s) of the transmission 130 (e.g., the transmission control unit 30 may control which gear the transmission 130 is in). The engine control unit 40 may control the overall operation and operating point of the engine 100 according to commands from the hybrid control unit 10. The battery management system 50 may collect battery status information and use the same for charging and discharging control of the battery 160 or provide the same to the hybrid control unit 10.

Since a decrease in the output shaft torque caused by friction loss in a handover period is proportional to an increase in the clutch torque on the engagement side, an input shaft compensation torque (i.e., a decrease in the output shaft torque) required in the handover period can be determined based on the state of the clutch on the engagement side (torque increase rate and torque amount).

According to an embodiment of the present disclosure, the transmission control unit 30 may determine the input shaft compensation torque for compensating for the decrease in the output shaft torque that occurs in a handover period in consideration of the state of the clutch on the engagement side and the vehicle speed.

Since the clutch torque on the engagement side gradually increases from a handover start time to a handover end time, the input shaft compensation torque should also gradually increase from the handover start time to the handover end time according to a handover ratio to prevent the occurrence of a feeling of sudden starting and an unfamiliar shifting feeling.

According to an embodiment of the present disclosure, the transmission control unit 30 may determine the handover ratio such that control for shifting can be performed by reflecting or based on the handover ratio. Here, the handover ratio may have a value between 0 and 1. According to the present disclosure, the handover ratio may vary from 0 at the handover start time to 1 at the handover end time.

For example, the transmission control unit 30 may determine the handover ratio based on a progress time or the amount of torque increase currently occurring for a target clutch torque on the engagement side (corresponding to a clutch torque on the engagement side at the handover end time).

According to the embodiment of the present disclosure, the hybrid control unit 10 may determine whether driving of the rear wheel motor 170 is necessary to compensate for the decrease in the output shaft torque caused by friction loss in a handover period based on the sum of an input shaft torque (starting point input torque) and an input shaft compensation torque at the handover start time, and a maximum input torque set in advance for the transmission 130.

The hybrid control unit 10 can determine whether the decrease in the output shaft torque caused by the friction loss in the handover period can be compensated for using the front wheel motor 120.

For example, the hybrid control unit 10 may apply an EV maximum torque as the maximum input torque when the vehicle driving mode is a charge-depleting (CD) mode, and may apply a maximum torque per stage as the maximum input torque when the vehicle driving mode is a charge-sustaining (CS) mode.

Upon determining that driving of the rear wheel motor 170 is not necessary to compensate for the decrease in the output shaft torque, the hybrid control unit 10 may calculate the input shaft torque for the front wheel motor 120 by adding a final compensation torque (handover ratio*input shaft compensation torque) calculated by multiplying the handover ratio by the input shaft compensation torque to the starting point input torque. The hybrid control unit 10 may output a command including the input shaft torque to the first motor control unit 21 of the motor control unit 20.

Accordingly, the first motor control unit 21 can control the front wheel motor 120 based on the input shaft torque corresponding to the command of the hybrid control unit 10. The front wheel motor 120 may operate according to control of the first motor control unit 21 to rotate the input shaft 131.

Therefore, the hybrid control unit 10 may perform handover by increasing the input shaft torque by the final compensation torque from the starting point input torque, and can compensate for the decrease in the output shaft torque by increasing the input shaft torque during handover.

Upon determining that driving of the rear wheel motor 170 is necessary to compensate for the decrease in the output shaft torque, the hybrid control unit 10 can calculate a compensation torque for the rear wheel motor 170.

According to an embodiment, the hybrid control unit 10 may calculate a compensation torque compensated or provided by the rear wheel motor 170 by multiplying an insufficient or deficient compensation torque of the front wheel motor 120 by the ratio of a final gear ratio of the rear wheel motor to the final gear ratio of the front wheel motor.

The hybrid control unit 10 may calculate the input shaft torque for the front wheel motor 120 by adding the final compensation torque (handover ratio*input shaft compensation torque) calculated by multiplying the handover ratio by the input shaft compensation torque to the starting point input torque.

In addition, the hybrid control unit 10 may calculate a rear wheel motor compensation torque by multiplying the compensation torque of the rear wheel motor 170 by the handover ratio.

According to the embodiment, the hybrid control unit 10 may output a command including the input shaft torque to the first motor control unit 21 of the motor control unit 20 and output a command including the rear wheel motor compensation torque to the second motor control unit 22 of the motor control unit 20.

Accordingly, the first motor control unit 21 can control the front wheel motor 120 based on the input shaft torque corresponding to the command of the hybrid control unit 10, and the front wheel motor 120 can operate according to control of the first motor control unit 21 to rotate the input shaft 131.

In addition, the second motor control unit 22 can control the rear wheel motor 170 based on the rear wheel motor compensation torque corresponding to the command of the hybrid control unit 10. The rear wheel motor 170 can operate according to control of the second motor control unit 22 to rotate the rear wheels RW.

Accordingly, the hybrid control unit 10 can control the front wheel motor 120 to increase the input shaft torque in a handover situation to compensate for the decrease in the output shaft torque, and drive the rear wheel motor 170 to compensate for the insufficient compensation torque of the front wheel motor 120.

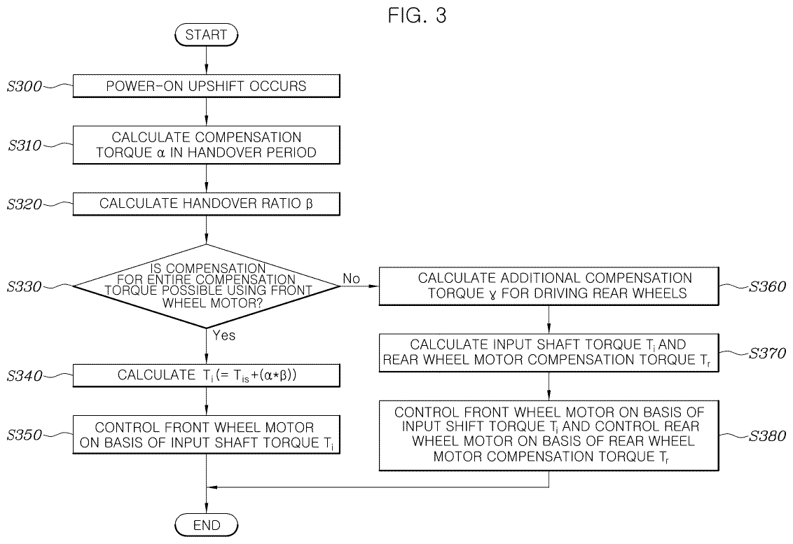

FIG. 3 is a diagram illustrating a vehicle driving control method according to an embodiment of the present disclosure.

The vehicle driving control method according to an embodiment of the present disclosure may include control for compensating for transmission clutch friction loss during shift control.

The vehicle driving control method according to an embodiment of the present disclosure is provided to compensate for a decrease in the torque of the output shaft 132 of the transmission 130 due to an increase in the torque of the engagement-side clutch during a handover by increasing the torque of the input shaft 131 when a hybrid vehicle enters power-on upshift, thereby maintaining a constant torque of the output shaft 132 of the transmission 130 in a handover situation.

In addition, the vehicle driving control method according to an embodiment of the present disclosure is provided to compensate for an insufficient compensation torque of the front wheel motor 120 by driving the rear wheel motor 170 when a decrease in the torque of the output shaft 132 of the transmission 130 cannot be compensated for only by increasing the torque of the input shaft 131.

Referring to FIGS. 1-3, when power-on upshift occurs in the vehicle (S300), the transmission control unit 30 of the vehicle driving control apparatus 1 may calculate an input shaft compensation torque α in a handover period (S310).

In step S310, the transmission control unit 30 may calculate the input shaft compensation torque α in the handover period based on the following mathematical expression 1.

$$α = \frac{( {ω}_{i} - {ω}_{y} ) \times ( {T}_{y} - {T}_{y e} )}{{ω}_{i}} \times F \qquad [ Mathematical expression 1 ]$$

Here, ωᵢ is the input shaft speed, ω_{y} is the rpm of the engagement-side clutch, T_{y} is the engagement-side clutch torque (target engagement-side clutch torque) at the handover end time, T_{ye} is the engagement-side clutch torque at the handover start time, and F is a correction coefficient.

In addition, the transmission control unit 30 may calculate a handover ratio β (S320). For example, the transmission control unit 30 may calculate the handover ratio β based on a time ratio or a torque ratio.

In step S320, the transmission control unit 30 may calculate a handover ratio β₁ using the ratio of the progress time from the handover start time to the current time to a target progress time of handover, as represented by the following mathematical expression 2.

$${β}_{1} = \frac{\begin{matrix}progress time from handover \\ start time to current time\end{matrix}}{target progress time of handover} \qquad [ Mathematical expression 2 ]$$

In step S320, the transmission control unit 30 may calculate a handover ratio β₂ based on the ratio of the current torque increase in the engagement-side clutch (current clutch torque on the engagement side-initial clutch torque on the engagement side) to a target torque increase in the engagement-side clutch (target clutch torque on the engagement side-initial clutch torque on the engagement side), as represented by the following mathematical expression 3.

$${β}_{2} = \frac{\begin{matrix}current clutch torque on \\ engagement side - initial clutch \\ torque on engagement side\end{matrix}}{\begin{matrix}target clutch torque on \\ engagement side - initial clutch \\ torque on engagement side\end{matrix}} \qquad [ Mathematical expression 3 ]$$

In this manner, when the handover ratio is calculated by two methods, the transmission control unit 30 can finally determine the handover ratio having the smaller value between the two handover ratios β₁ and β₂ as the handover ratio 3.

The transmission control unit 30 may provide the input shaft compensation torque α and the handover ratio β for the handover period to the hybrid control unit 10.

Thereafter, the hybrid control unit 10 may determine whether compensation for the entire input shaft compensation torque is possible using the front wheel motor 120 (S330).

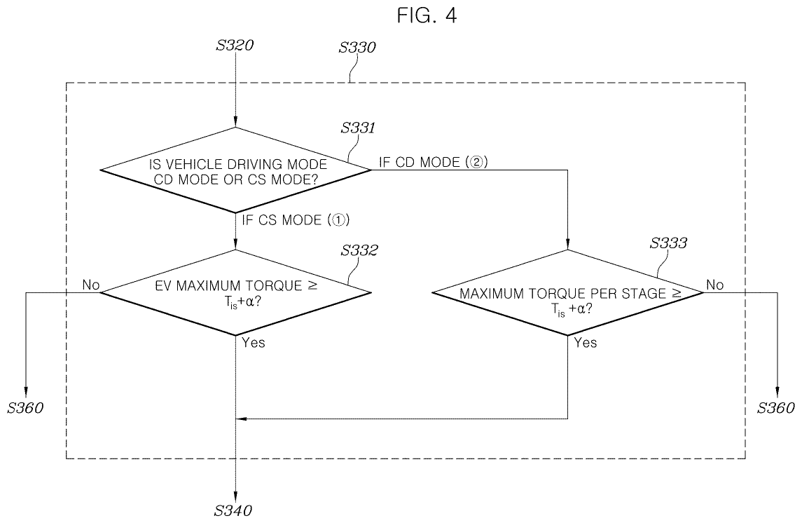

FIG. 4 is a diagram illustrating a specific process of step S330 of FIG. 3.

Referring to FIG. 4, the hybrid control unit 10 may determine whether the vehicle driving mode is a charge-depleting (CD) mode or a charge-sustaining (CS) mode (S331). If the vehicle driving mode is the CD mode \textcircled{1}, the hybrid control unit 10 may determine whether the sum Tᵢₛ+α of the torque (starting point input shaft torque) Tᵢₛ of the input shaft 131 and the input shaft compensation torque α at the handover start time is equal to or less than a maximum torque in the EV mode (EV maximum torque) (S332).

If the sum Tᵢₛ+α of the starting point input shaft torque Tᵢₛ and the input shaft compensation torque α is equal to or less than the EV maximum torque (S332—Yes), the hybrid control unit 10 may perform step S340. If the sum Tᵢₛ+α of the starting point input shaft torque Tᵢₛ and the input shaft compensation torque α is greater than the EV maximum torque (S332—No), the hybrid control unit 10 may perform step S360.

When the vehicle driving mode is the CS mode \textcircled{2}, the hybrid control unit 10 may determine whether the sum Tᵢₛ+α of the starting point input shaft torque Tᵢₛ and the input shaft compensation torque α is equal to or less than a maximum torque per stage (S333).

If the sum Tᵢₛ+α of the starting point input shaft torque Tᵢₛ and the input shaft compensation torque α is equal to or less than the maximum torque per stage (S333—Yes), the hybrid control unit 10 may perform step S340. If the sum Tᵢₛ+α of the starting point input shaft torque Tᵢₛ and the input shaft compensation torque α is greater than the maximum torque per stage (S333—No), the hybrid control unit 10 may perform step S360.

Referring back to FIG. 3, if compensation for the entire input shaft compensation torque is possible using the front wheel motor 120 (S330—Yes), the hybrid control unit 10 may calculate an input shaft torque Tᵢ for the front wheel motor 120 by adding the starting point input shaft torque Tᵢₛ to the product α*β of the input shaft compensation torque α and the handover ratio β (S340).

The hybrid control unit 10 can calculate the input shaft torque Tᵢ including the input shaft compensation torque α*β according to the handover ratio.

Here, the case where compensation for the entire input shaft compensation torque is possible using the front wheel motor 120 may correspond to a case where the sum Tᵢₛ+α of the starting point input shaft torque Tᵢₛ and the input shaft compensation torque α is equal to or less than the EV maximum torque the vehicle driving mode is the CD mode and may correspond to a case where the sum Tᵢₛ+α of the starting point input shaft torque Tᵢₛ and the input shaft compensation torque α is equal to or less than the maximum torque per stage when the vehicle driving mode is the CS mode.

Thereafter, the hybrid control unit 10 may output the input shaft torque Tᵢ to the first motor control unit 21 of the motor control unit 20 such that the first motor control unit 21 can control the front wheel motor 120 based on the input shaft torque Tᵢ (S350).

Accordingly, the input shaft torque Tᵢ can be applied to the input shaft 131 by the front wheel motor 120 driven under the control of the first motor control unit 21.

If compensation for the entire input shaft compensation torque α is not possible using the front wheel motor 120 (S330—No), the hybrid control unit 10 may calculate an additional compensation torque γ in order to compensate for an insufficient compensation torque that has not been compensated for by the front wheel motor 120 by using the rear wheel motor 170 (S360).

In step S360, the hybrid control unit 10 may calculate the additional compensation torque γ by multiplying a front wheel motor insufficient compensation torque (Tᵢₛ+α-maximum torque) by the ratio of the front wheel motor final gear ratio to the rear wheel motor final gear ratio, as represented by the following mathematical expression 4.

$$γ = \frac{front wheel motor final gear ratio}{rear wheel motor final gear ratio} \times ( {T}_{i s} + α - maximum torque ) \qquad [ Mathematical expression 4 ]$$

Here, the maximum torque may be the EV maximum torque when the vehicle driving mode is the CD mode, and the maximum torque per stage when the vehicle driving mode is the CS mode.

In addition, the front wheel motor final gear ratio may be the gear ratio of the front wheel final reduction gear 140, and the rear wheel motor final gear ratio may be the gear ratio of the rear wheel final reduction gear 180.

Thereafter, the hybrid control unit 10 may calculate the input shaft torque Tᵢ for the front wheel motor 120 by adding the starting point input shaft torque Tᵢₛ to the product α*β of the input shaft compensation torque α and the handover ratio β, and calculate a rear wheel motor compensation torque Tᵣ by multiplying the additional compensation torque γ by the handover ratio β (S370).

Thereafter, the hybrid control unit 10 may output the input shaft torque Tᵢ to the first motor control unit 21 of the motor control unit 20 such that the first motor control unit 21 may control the front wheel motor 120 based on the input shaft torque Tᵢ, and output the rear wheel motor compensation torque Tᵣ to the second motor control unit 22 of the motor control unit 20 such that the second motor control unit 22 controls the rear wheel motor 170 based on the rear wheel motor compensation torque Tᵣ (S380).

Accordingly, the input shaft torque Tᵢ including input shaft compensation torque α*β according to the handover ratio can be applied to the input shaft 131 by the front wheel motor 120 driven according to control of the first motor control unit 21.

In addition, since the rear wheels RW are driven by the rear wheel motor 170 driven according to control of the second motor control unit 22, it is possible to compensate for the insufficient compensation torque that has not been compensated for by the front wheel motor 120.

In this manner, the hybrid control unit 10 can increase the input shaft torque in a handover situation by controlling the front wheel motor 120 to compensate for a decrease in the output shaft torque, and drive the rear wheel motor 170 to compensate for the insufficient compensation torque of the front wheel motor 120.

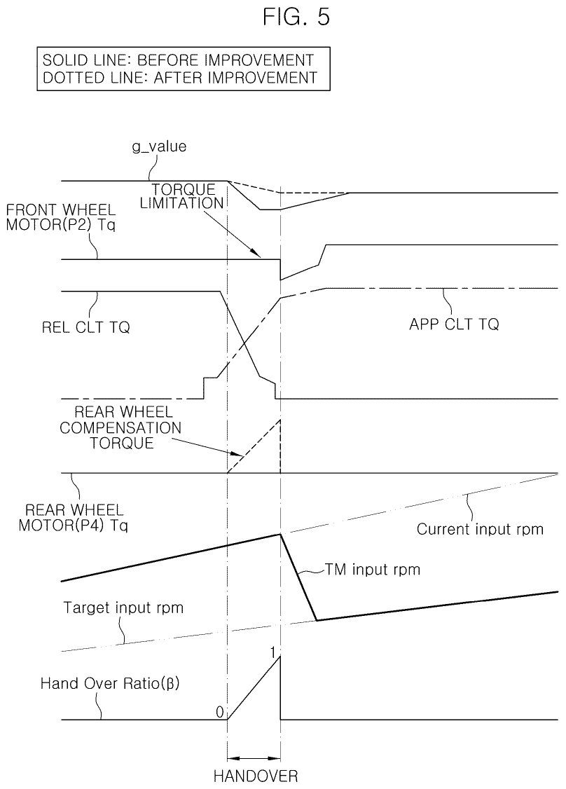

FIG. 5 is a graph showing improvement of acceleration linearity in a handover period in a situation in which the torque of the front wheel motor is limited when the vehicle driving control method according to an embodiment of the present disclosure is applied.

In order to compensate for a decrease in the output shaft torque that occurs in a handover period during power-on upshift, the input shaft torque of the front wheel motor needs to be increased.

Conventionally, when the torque of the front wheel motor is limited, a decrease in the output shaft torque cannot be compensated for, and thus the acceleration linearity in a handover period inevitably deteriorates (refer to the solid line of g_value).

However, according to embodiments of the present disclosure, in a situation in which the input shaft torque of the front wheel motor cannot be increased due to limitation of the torque of the front wheel motor, the rear wheel motor is controlled based on the rear wheel motor compensation torque corresponding to the insufficient compensation torque that is not compensated for by the front wheel motor, thereby improving the acceleration linearity in a handover period (refer to the dotted line of g_value).

According to the embodiments of the present disclosure, since the rear wheel motor compensation torque is calculated depending on the handover ratio β, the rear wheel motor compensation torque can be increased in proportion to the handover ratio β.

According to the embodiments of the present disclosure, it is possible to provide an improved vehicle driving control apparatus and method capable of maintaining acceleration linearity in a handover period during power-on upshift.

According to the embodiments of the present disclosure, it is possible to provide an improved vehicle driving control apparatus and method capable of compensating for clutch friction loss of a transmission even when clutch friction loss compensation using only the margin of a front wheel motor is impossible due to a torque limitation of the front wheel motor.

According to the embodiments of the present disclosure, it is possible to provide an improved vehicle driving control apparatus and method capable of compensating for insufficient compensation torque which has not and/or cannot be compensated by the front wheel motor among input shaft compensation torques, by using driving of the rear wheel motor.

When the vehicle driving control apparatus and method according to the embodiments of the present disclosure are applied to a vehicle, even when clutch friction loss occurring in a handover period during power-on upshift cannot be compensated using a margin torque of the front wheel motor, clutch friction loss can be compensated using the rear wheel motor.

Therefore, consistent acceleration linearity can be provided in a power-on upshift situation. Accordingly, it is possible to prevent the occurrence of a feeling of deceleration, a feeling of power cut-off or power loss, and an unfamiliar shifting feeling due to a decrease in output-side torque, and to maintain acceleration linearity, thereby improving ride comfort and ensuring shifting consistency and robustness.

The effects obtained from the present disclosure are not limited to the effects mentioned above, and other effects not mentioned should be clearly understood by those of ordinary skill in the art to which the present disclosure belongs from the description below.

While the present disclosure has been illustrated and described with respect to specific embodiments thereof, it should be apparent to those of ordinary skill in the art that the present disclosure may be modified and altered in various manners without departing from the technical spirit of the present disclosure as defined by the following claims.

What is claimed is:

1. An apparatus configured to control driving of a vehicle including a transmission arranged between a first driving wheel and a first motor, and a second motor connected to a second driving wheel, the apparatus comprising:
a first controller configured to, based on power-on upshift occurring in the transmission, determine an input shaft compensation torque and a handover ratio over a handover period; and
a second controller configured to determine whether compensation for the entire input shaft compensation torque is possible using the first motor and to control the first motor or control the first motor and the second motor, based on the input shaft compensation torque and the handover ratio according to a determination result whether compensation is possible using the first motor and not the second motor.

2. The apparatus of claim 1, wherein the first controller is configured to determine the input shaft compensation torque α based on mathematical expression 1,
$$α = \frac{( {ω}_{i} - {ω}_{y} ) \times ( {T}_{y} - {T}_{y e} )}{{ω}_{i}} \times F \qquad [ Mathematical expression 1 ]$$
wherein ωᵢ is an input shaft speed, ω_{y} is rpm of an engagement-side clutch, T_{y} is an engagement-side clutch torque at a handover end time, T_{ye} is an engagement-side clutch torque at a handover start time, and F is a correction coefficient.

3. The apparatus of claim 1, wherein the first controller is configured to determine a smaller value between a first handover ratio determined based on a time ratio and a second handover ratio determined based on a torque ratio as the handover ratio.

4. The apparatus of claim 1, wherein the second controller is configured to determine whether compensation for the entire input shaft compensation torque is possible using the first motor based on a result of comparison between a sum of a starting point input torque corresponding to a torque of an input shaft at a handover start time and the input shaft compensation torque, and a maximum input torque preset for the transmission.

5. The apparatus of claim 4, wherein the second controller is configured to, based on a driving mode of the vehicle being charge-depleting (CD) mode, apply an EV maximum torque corresponding to a maximum torque in an EV mode as the maximum input torque, and determine that compensation for the entire input shaft compensation torque is not possible using the first motor based on the sum of the starting point input torque and the input shaft compensation torque being greater than the EV maximum torque.

6. The apparatus of claim 4, wherein the second controller is configured to, based on the driving mode of the vehicle being a charge-sustaining (CS) mode, apply a maximum torque per stage as the maximum input torque, and determine that compensation for the entire input shaft compensation torque is not possible using the first motor based on the sum of the starting point input torque and the input shaft compensation torque being greater than the maximum torque per stage.

7. The apparatus of claim 1, wherein, based on determining that compensation for the entire input shaft compensation torque is possible using the first motor, the second controller is configured to determine an input shaft torque for the first motor based on the input shaft compensation torque, the handover ratio, and the starting point input torque corresponding to the torque of the input shaft at the handover start time, and output the input shaft torque to a first motor controller for controlling the first motor.

8. The apparatus of claim 7, wherein the second controller is configured to determine the input shaft torque for the first motor by adding a product of the input shaft compensation torque and the handover ratio to the starting point input torque.

9. The apparatus 4 claim 1, wherein the second controller is configured to determine an additional compensation torque to be applied by the second motor to compensate for an insufficient compensation torque that has not been compensated for using the first motor based on determining that compensation for the entire input shaft compensation torque is not possible using the first motor.

10. The apparatus of claim 9, wherein the second controller is configured to determine the additional compensation torque γ based on mathematical expression 4,
$$γ = \frac{front wheel motor final gear ratio}{rear wheel motor final gear ratio} \times ( {T}_{i s} + α - maximum torque ) \qquad [ Mathematical expression 4 ]$$
wherein Tᵢₛ is the starting point input torque corresponding to the torque of the input shaft at the handover start time, α is the input shaft compensation torque, the front wheel motor final gear ratio is a gear ratio of a front wheel final reduction gear, the rear motor final gear ratio is a gear ratio of a rear wheel final reduction gear, and the maximum torque is the EV maximum torque in the CD mode and the maximum torque per stage in the CS mode.

11. The apparatus of claim 9, wherein the second controller is configured to determine the input shaft torque for the first motor based on the input shaft compensation torque, the handover ratio, and the starting point input torque corresponding to the torque of the input shaft at the handover start time, and determine a rear wheel motor compensation torque based on the additional compensation torque and the handover ratio.

12. The apparatus of claim 11, wherein the second controller is configured to determine the input shaft torque for the first motor by adding the product of the input shaft compensation torque and the handover ratio to the starting point input torque.

13. The apparatus of claim 11, wherein the second controller is configured to determine the rear wheel motor compensation torque by multiplying the additional compensation torque by the handover ratio.

14. The apparatus of claim 11, wherein the second controller is configured to output the input shaft torque to the first motor controller for controlling the first motor, and output the rear wheel motor compensation torque to a second motor controller for controlling the second motor.

15. The apparatus of claim 14, wherein the first motor controller is configured to control the first motor based on the input shaft torque such that the transmission operates at a maximum torque, and the second motor controller is configured to control the second motor based on the rear wheel motor compensation torque such that an insufficient compensation torque that has not been compensated using the first motor in the input shaft compensation torque is compensated for according to driving of the second motor.

16. A method of controlling driving of a vehicle including a transmission arranged between a first driving wheel and a first motor and a second motor connected to a second driving wheel, the method comprising:
determining, by a first controller, an input shaft compensation torque and a handover ratio over a handover period based on power-on upshift occurring in the transmission;
determining, by a second controller, whether compensation for the entire input shaft compensation torque is possible using the first motor; and
controlling the first motor or controlling the first motor and the second motor, by the second controller, based on the input shaft compensation torque and the handover ratio according to a determination result whether compensation is possible using the first motor and.

17. A vehicle comprising:
a first powertrain including a first motor and a transmission arranged between the first motor and a first driving wheel;
a second powertrain including a second motor connected to a second driving wheel; and
a vehicle driving control apparatus configured to control the first powertrain and the second powertrain,
wherein, based on power-on upshift occurring in the transmission, the vehicle driving control apparatus is configured to determine an input shaft compensation torque and a handover ratio, determine whether compensation for the entire input shaft compensation torque is possible using the first motor, and control the first motor or control the first motor and the second motor based on the input shaft compensation torque and the handover ratio according to a determination result whether compensation is possible using the first motor.

18. The vehicle of claim 17, wherein the vehicle control apparatus is configured to determine whether compensation for the entire input shaft compensation torque is possible using the first motor based on a result of comparison between a sum of a starting point input torque corresponding to a torque of an input shaft at a handover start time and the input shaft compensation torque, and a maximum input torque preset for the transmission.

19. The vehicle of claim 17, wherein the vehicle control apparatus is configured to determine a smaller value among a first handover ratio determined based on a time ratio and a second handover ratio determined based on a torque ratio as the handover ratio.

20. The vehicle of claim 17, wherein the vehicle control apparatus is configured to determine an additional compensation torque to be applied by the second motor to compensate for an insufficient compensation torque that has not been compensated for using the first motor based on determining that compensation for the entire input shaft compensation torque is not possible using the first motor.
